(19) United States
(12) Patent Application Publication
(10) Pub. No.: US 2009/0182468 A1
(43) Pub. Date: Jul. 16, 2009

(54) Understeer/Oversteer Correction for All Wheel Drive Vehicle

(75) Inventor: Brian B. Ginther, Rochester Hills, MI (US)

Correspondence Address: WARN, HOFFMANN, MILLER & LALONE, .P.C, PO BOX 70098, ROCHESTER HILLS, MI, 48307, US

(73) Assignee: BORGWARNER INC., Auburn Hills, MI (US)

(21) Appl. No.: 12/224,539

(22) PCT Filed: Mar. 28, 2007
(86) PCT No.: PCT/US2007/007623

§ 371 Date: Nov. 12, 2008

Related U.S. Application Data
(60) Provisional application No. 60/786,448, filed on Mar. 28, 2006.

(51) Int. Cl. B60K 23/08

(52) U.S. Cl. 701/42

(57) ABSTRACT

A method for correcting an understeer/oversteer condition of an all wheel drive vehicle (10) by altering the torque delivered to at least one axle (14) of the vehicle is provided. The method includes a step of determining the vehicle speed and lateral acceleration (102). A calculation is made of a neutral steer value of the vehicle based in part upon vehicle speed, vehicle lateral acceleration, and vehicle wheel base length (104). An actual steering angle of the vehicle is also determined (108). A chassis function ratio is determined based in part upon one vehicle physical characteristic and one vehicle operating condition (110). An error signal is calculated based upon a function of the steering angle, neutral steering value, lateral acceleration and chassis function ratio (106). The torque delivered to at least one axle is modified based upon the error signal.

### CROSS-REFERENCE TO RELATED APPLICATIONS

This application claims the benefit of U.S. Provisional Application No. 60/786,448, filed Mar. 28, 2006.

### FIELD OF THE INVENTION

The present invention relates to an understeer/oversteer correction for an all wheel drive vehicle (AWD).

### BACKGROUND OF THE INVENTION

All wheel drive vehicles typically use a coupling mechanism to distribute torque between the front and rear axles. In the case of a primary rear wheel AWD vehicle, the torque is almost always delivered to the rear axle. On satisfaction of certain predetermined conditions, the coupling will deliver torque to the front or secondary axle. When the AWD vehicle is going around a curve, the front and rear wheels can turn at different speeds. If the torque applied to the front axle is too great then the vehicle will understeer or cause a driver to notice a “push” sensation as the vehicle turns. If the torque applied to the rear axle is too great then the vehicle will oversteer or “pull” as the vehicle turns. In order to eliminate these understeer and oversteer sensations it is desirable to provide a vehicle that is capable of achieving as close to a neutral steer sensation as possible. That is, there is little or no understeering or oversteering as the vehicle goes around a corner.

### SUMMARY OF THE INVENTION

The present invention is directed to a method and arrangement for reducing an understeer/oversteer condition of a vehicle in motion. The present invention provides a method for correcting an understeer/oversteer condition of an all wheel drive vehicle by altering the torque delivered to at least one axle of the vehicle, the method includes a step of determining the vehicle speed and lateral acceleration. A calculation is made of a neutral steer value of the vehicle based at least in part upon vehicle speed, vehicle lateral acceleration, and vehicle wheel base length. An actual steering angle of the vehicle is also determined. A chassis function ratio is determined based at least in part upon one vehicle physical characteristic and one vehicle operating condition. An error signal is calculated based upon a function of the actual steering angle, neutral steering value, lateral acceleration and chassis function ratio. The torque delivered to at least one axle is modified based upon the error signal.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a vehicle incorporating the understeer/oversteer correction method and arrangement; and

FIG. 2 is a flow chart showing the steps of calculating the understeer/oversteer correction torque request signal.

### DETAILED DESCRIPTION OF THE PREFERRED EMBODIMENTS

The following description of the preferred embodiments is merely exemplary in nature and is in no way intended to limit the invention, its application, or uses.

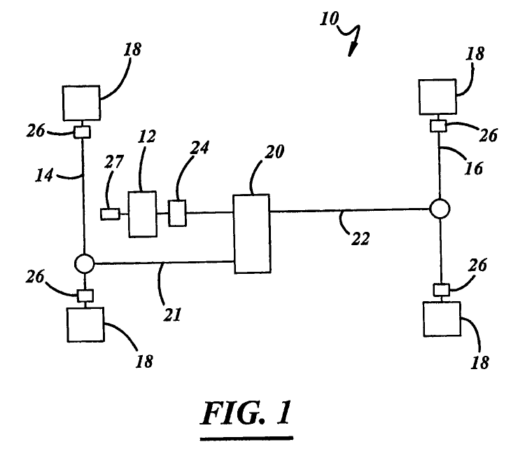

Referring to FIG. 1, an all wheel drive (AWD) vehicle having an understeer/oversteer correction system is generally shown at 10. The vehicle 10 has an engine 12 which is torsionally operably connected to a primary rear axle 16 and a steered secondary front axle 14. However, it should be appreciated that the primary axle can be the front axle 14 and the secondary axle can be the rear axle 16. For purposes of the explanation below, the rear axle 16 is the primary axle and the front axle 14 is the secondary axle.

Wheels 18 are connected with both ends of the front axle 14 and rear axle 16. Typically, a coupling 20 is placed on a drive shaft 22 between the engine 12 and the rear axle 16. A shaft 21 delivers torque from the coupling 20 to the front axle 14. A controller or control unit 24 is then used to control the amount of torque applied to the front axle 14 through the coupling 20. Furthermore, sensors 26 are placed on the vehicle 10 in order to determine vehicle operating conditions, in which the data from the sensors 26 is then transmitted to the control unit 24. The control unit 24 then determines the amount of torque applied by the engine 12 to the front axle 14 and rear axle 16. The total amount of torque transferred from the engine 12 to the axles 14, 16 is controlled by a throttle 27 which is operated by a driver of the vehicle 10. Thus, depending on the position of the throttle 27 and the rate of change of the position of the throttle 27, otherwise known as the throttle 27 rack, the amount of torque transferred from the engine 12 to the axles 14, 16 is changed.

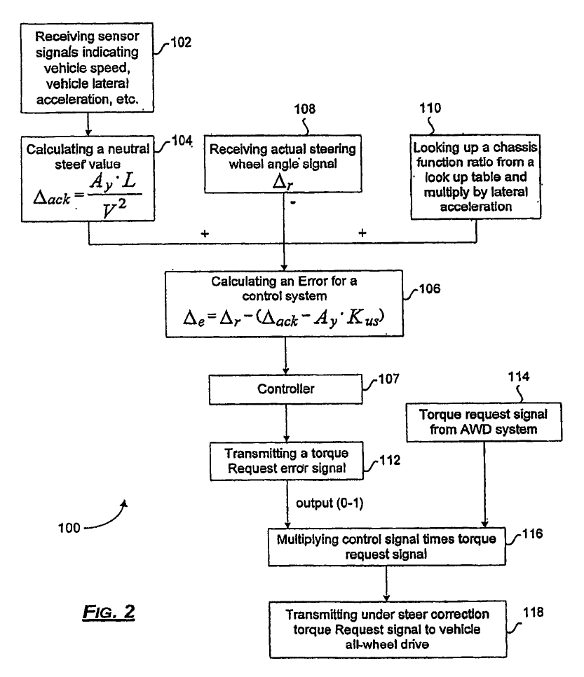

Referring to FIG. 2 a flow chart showing the steps of calculating the understeer/oversteer correction torque request signal is depicted. The steps outlined in this flow chart can take place in a single component control unit 24; however, it is possible for the multiple control functions to be incorporated into a multiple component control unit. FIG. 2 represents an overall method 100 where an understeer/oversteer correction torque request signal is ultimately generated. The understeer/oversteer correction torque request signal adjusts torque on the front axle of the vehicle in a turning situation in order to achieve as close to a neutral steer effect while taking into account the torque at each of the wheels. The method calculates the amount of error or corrected torque using the following equation:

Δₑ=Δᵣ−(Δ_{ack}−A_{y}·Kᵤₛ)

Where Δₑ is the control error signal, Δ_{ack} is the Ackerman steer value, A_{y} is the lateral acceleration of the vehicle and Kᵤₛ is a chassis function value. Δᵣ is a value of the actual front wheel steering angle. The Δₑ value can be a positive or negative value. This will depend on whether or not the steering wheel angles are for a left or right side of the vehicle. The method can be configured so positive values are for the right side of the vehicle and negative values are for the left side or vice-versa. Δ_{ack} is calculated using the following equation:

$${Δ}_{ack} = \frac{Ay \cdot L}{{V}^{2}}$$

Where A_{y} is lateral acceleration of the vehicle, L is the vehicle wheel base and v is the vehicle speed. Using the above two equations a understeer/oversteer correction torque request signal can be derived.

The method of calculating the understeer/oversteer correction torque request signal begins at step 102 where the controller receives sensor signals indicating the vehicle speed, lateral acceleration and/or other suitable variables. Some of the signal will be from the sensors 26. At step 104 the actual values received by the sensors are used to calculate the Δack value using the following equation:

$$Δ ack = \frac{Ay \cdot L}{{V}^{2}}$$

Once the Ackerman steer value (neutral steer value) has been calculated this value will be used to calculate the error for the control system at a step 106. At a step 107 the calculated value from step 106 is process through a controller in order to convert the value to the proper signal being used in the drive system. it by the vehicle lateral acceleration (A_{y}) at step 106. This multiplied chassis function ratio (Kᵤₛ) will be used at step 106 along with the actual front wheel steering angle (Δᵣ) value and the calculated Ackerman steer value (Δack) in order to calculate the error (Δₑ) for the control signal at step 106. The error for the control signal value is then used at a step 112 where a torque request error signal is transmitted. The output will typically be a value near the values of 0 and 1. At a step 114 a torque request signal from the all wheel drive system is transmitted to the controller. The torque request signal is dependent upon the amount of torque being requested by the vehicle operator. At step 116 the torque request signal is multiplied by the torque request error signal and ultimately at step 118 an understeer/oversteer correction torque request signal is transmitted from the controller.

The above noted chassis function ratio is a predetermined value based upon at least one physical vehicle characteristic and at least one vehicle operating condition. For example, the physical vehicle characteristic can be based upon factors such as, but not limited to, vehicle wheel base length, vehicle weight, and vehicle height. The vehicle height and weight can be fixed, pre-programmed values or variable active values taken from actual data from the vehicle suspension system. The operating variables that can affect chassis function can be torque requests, steering angle, vehicle speed, vehicle lateral acceleration or transmission gear ratio. Other operating variables can be used. On many premium vehicles an operator can select a plurality of operating modes of the drive train or suspension. The chassis function ratio can be made to be dependent upon the multiple operating capabilities of the vehicle.

The description of the invention is merely exemplary in nature and, thus, variations that do not depart from the gist of the invention are intended to be within the scope of the invention. Such variations are not to be regarded as a departure from the spirit and scope of the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for correcting an understeer/oversteer condition of an all wheel drive vehicle by altering the torque delivered to at least one axle of said vehicle, said method comprising:
determining said vehicle speed and lateral acceleration;
calculating a neutral steer value based upon at least vehicle speed, lateral acceleration and wheel base length;
determining an actual steering angle of said vehicle;
determining a chassis function ratio based upon at least one vehicle physical characteristic and one vehicle operating condition; and
calculating an error signal based upon a function of said steering angle, neutral steer value, lateral acceleration and chassis function ratio; and
modifying the torque delivered to at least one axle based upon said error signal.

2. A method as described in claim 1 wherein a secondary axle has its torque modified by said error signal.

3. A method as described in claim 1 wherein a steered axle has its torque modified by said error signal.

4. A method as described in claim 1 wherein said neutral steer value is at least in part determined by multiplying said lateral acceleration by wheel base length and dividing the product by a squaring of the velocity.

5. A method as described in claim 1 wherein said chassis function ratio physical characteristic is taken from at least one of the group including vehicle height, vehicle wheel base length and vehicle weight.

6. A method as described in claim 5 wherein said vehicle height is variable.

7. A method as described in claim 5 wherein said vehicle weight is variable.

8. A method as described in claim 1 wherein said chassis function ratio is taken from at least one of the group of operating conditions including torque request, steering angle and vehicle speed, vehicle lateral acceleration, transmission gear ratio.

9. The method as described in claim 1 further comprising the step of receiving a mode signal when determining said chassis function ratio, wherein said vehicle is capable of operating in one of a plurality of modes, such that said chassis function ratio is additionally dependent upon said mode signal.

10. The method as described in claim 1 further comprising the step of at least one sensor determining at least one vehicle operating condition.

11. The method as described in claim 4 wherein said chassis function ratio is multiplied by said vehicle lateral acceleration condition when calculating said control error.

12. The method as described in claim 11 further including the step of subtracting the product of said chassis function ratio and said vehicle lateral acceleration from said neutral steer value and therefore subtracting the result for said actual steering wheel angle.

13. A method for correcting an understeer/oversteer condition of an all wheel drive vehicle by altering the torque delivered to at least a secondary axle of said vehicle, said method comprising:
determining said vehicle speed and lateral acceleration;
calculating a neutral steer value based upon at least vehicle speed, lateral acceleration and wheel base length;
determining an actual steering angle of said vehicle;
determining a chassis function ratio based upon at least one vehicle physical characteristic and one vehicle operating condition; and
calculating an error signal based upon subtracting from said actual steering angle a result of neutral steer value minus the product of lateral acceleration times chassis function ratio; and
modifying the torque delivered to said secondary axle based upon said error signal.

14. An all wheel drive vehicle having front and rear axles and a coupler to at least one axle, said coupler being controlled by a controller for correcting an understeer/oversteer condition of an all wheel drive vehicle by altering the torque delivered to at least one axle of said vehicle, said controller:
determines said vehicle speed and lateral acceleration;
calculates a neutral steer value based upon at least vehicle speed, lateral acceleration and wheel base length;
determines an actual steering angle of said vehicle;
determines a chassis function ratio based upon at least one vehicle physical characteristic and one vehicle operating condition; and
calculates an error signal based upon a function of said steering angle, neutral steer value, lateral acceleration and chassis function ratio; and
modifies the torque delivered to at least one axle based upon said error signal.

15. A vehicle as described in claim 14 wherein a secondary axle has its torque modified by said error signal.

16. A vehicle as described in claim 14 wherein said secondary axle is said front axle.

17. A vehicle as described in claim 14 wherein a steered axle has its torque modified by said error signal.

18. A vehicle as described in claim 14 wherein said chassis function ratio physical characteristic is taken from at least one of the group including vehicle height, vehicle wheel base length and vehicle weight.

19. The vehicle as described in claim 14 wherein said controller can receive a mode signal when determining said chassis function ratio, wherein said vehicle is capable of operating in one of a plurality of modes, such that said chassis function ratio is additionally dependent upon said mode signal.

20. A vehicle as described in claim 14 wherein said controller calculates said error signal by subtracting from the actual steering angle a result of neutral steer value minus the product of lateral acceleration times chassis function ratio.
